(19) United States
(12) Patent Application Publication
(10) Pub. No.: US 2011/0317406 A1
(43) Pub. Date: Dec. 29, 2011

(54) STRUCTURE OF SAFETY LED (LIGHT-EMITTING DIODE) LIGHTING TUBE

(75) Inventors: Ching Feng LIN, Taipei County (TW); Yung Han, Taipei County (TW)

(73) Assignee: JADE YANG CO., LTD., Taipei County (TW)

(21) Appl. No.: 12/956,029

(22) Filed: Nov. 30, 2010

(30) Foreign Application Priority Data
Jun. 24, 2010 (TW) 099212030

(51) Int. Cl. F21V 21/00

(52) U.S. Cl. 362/217.1

(57) ABSTRACT

A safety LED lighting tube has a light cover, a base, a circuit board, and two electrical connectors. The light cover has a semi-circular hollow body made of a moldable material and has two side edges extending inwards and recessed to form rail channels. The base has a semi-circular body made of a moldable material and has a lower surface from which two hooked flanges project for slidable engagement with the rail channels formed on the side edges of the light cover. Ribs are formed on inward edges of the hooked flanges. The circuit board is received between and is supported by the ribs formed on the inward edges of the hooked flanges of the lower surface of the base. The circuit board has at least one LED. The electrical connectors are respectively mounted to opposite ends of the base and are electrically connected to the circuit board.

### BACKGROUND OF THE INVENTION

1. Field of the Invention

The present invention is related to a structure of safety LED (Light-Emitting Diode) lighting tube, and more particular to a lighting tube for replacement of or being compatible with conventional fluorescent tube through an unique arrangement of a light cover, a base, circuit boards, and electrical terminals in which the light cover and the base are plastic moldings to which the circuit boards and electrical terminals are coupled to form a structure of lighting tube showing advantages of energy conservation, excellent heat dissipation performance, excellent illumination brightness, and improved safety of use.

2. Description of Related Art

Conventionally, a fluorescent lighting tube comprises an enclosed gas discharge tube, in which a gas of argon is filled. Additionally contained inside the tube is neon gas or krypton gas. The tube has an inside pressure that is maintained at around 0.3% of atmospheric pressure. By conducting an electrical current (through acceleration of electrons) inside the tube, gaseous electric discharge is induced to give off light.

The tube of the fluorescent lighting tube is often made of glass and a small amount of mercury is contained inside the tube. Care must be exercised in handling the fluorescent lighting tube in order not to unexpectedly break the tube, which may lead to leakage of and thus contamination caused by the mercury contained in the tube. Further, accident inhalation or contact of mercury by a person may hurt the person by inducing body intoxication. Further, although the conventional fluorescent tubes are of low costs, the used or wasted fluorescent tubes may cause mercury pollution and are of fragility.

The state-of-the-art improvement of lighting tube adopts light-emitting diodes (LEDs) as light sources. This renders the “new” lighting tube structurally different from the enclosed tubes of the conventional fluorescent tube. The LED based lighting tube is often made of aluminum extrusion due to heat dissipation requirement. Since aluminum is used, recycling of used LED based lighting tube becomes difficult. In addition, coupling of the aluminum tube with a cover or hood cannot be realized for tight engagement between the parts, for the aluminum part may get excessively hot to cause undesired deformation of the cover or hood.

Thus, in view of the above discussed drawbacks, the present invention aims to provide a structure of safety LED lighting tube that is easy for assembly and shows excellent heat dissipation performance, excellent illumination brightness, and improved safety.

### SUMMARY OF THE INVENTION

Accordingly, the primary objective of the present invention is to provide a structure of safety LED lighting tube, wherein an unique arrangement of a light cover, a base, circuit boards, and electrical terminals is provide, in which the light cover has side edges extending inward and recessed to form rail channels and the base has a lower surface from which hooked flanges project for slidable engagement and mating with the rail channels formed on the side edges of the light cover and in which ribs are formed on inward edges of the hooked flange so that the circuit boards are received and supported between the ribs formed on the inward edges of the hooked flanges formed on the lower surface of the base to thereby facilitate assembly and improve safety and thus enhance overall practicability.

Another objective of the present invention is to provide a structure of safety LED lighting tube, wherein the light cover and the base are made of moldable materials, which allows for easy change of colors thereof, so that diverse variation of color of light transmitting through the light cover can be made to thereby improve the overall convenience and also to allow for recycling of the moldable materials of these parts.

A further objective of the present invention is to provide a structure of safety LED lighting tube, wherein each of the circuit boards forms a projection and an opposite recess, so that the circuit boards can be easily jointed to each other, and the number of the circuit boards or LEDs used can be changed according to desired overall length and brightness of the lighting tube to thereby improve the overall practicability and functionality.

A further objective of the present invention is to provide a structure of safety LED lighting tube, wherein the base has an upper portion forming a plurality of fins to ensure excellent performance of heat dissipation to thereby improve overall practicability and extend lifespan.

According to the present invention, a structure of safety LED lighting tube is provided, comprising: a light cover, a base, a circuit board, and two electrical connectors. The light cover comprises a semi-circular hollow body made of a moldable material and has two side edges extending inwards and recessed to form rail channels. The base comprises a semi-circular body made of a moldable material and has a lower surface from which two hooked flanges project for slidable engagement with the rail channels formed on the side edges of the light cover. Ribs are formed on inward edges of the hooked flanges. The base has an upper portion forming a plurality of fins. The circuit board is received between and supported by the ribs formed on the inward edges of the hooked flanges of the lower surface of the base. The circuit board carrying thereon at least one LED. The electrical connectors are respectively mounted to opposite ends of the base and are electrically connected to the circuit board. The electrical connectors comprise contact terminals for electrical connection with an external power source. With such an arrangement, a structure of lighting tube that is advantageous in energy conversation, excellent heat dissipation performance, excellent brightness, recyclability, and improved safety is realized.

### BRIEF DESCRIPTION OF THE DRAWINGS

The present invention can be fully understood from the following detailed description of preferred embodiments with reference to the accompanying drawings, in which:

FIG. 1 is a perspective view illustrating an LED (Light-Emitting Diode) lighting tube according to an embodiment of the present invention;

FIG. 2 is an exploded view illustrating the LED lighting tube according to the present invention;

FIG. 3 is a cross-sectional view of the LED lighting tube according to the present invention, illustrating an arrangement of heat dissipation fins of the LED lighting tube;

FIG. 4 is a cross-sectional view of the LED lighting tube according to the present invention, illustrating another arrangement of heat dissipation fins of the LED lighting tube;

FIG. 5 is a plan view illustrating an arrangement of circuit boards of the LED lighting tube according to the present invention; and

FIG. 6 is a plan view illustrating another arrangement of circuit boards of the LED lighting tube according to the present invention.

### DETAILED DESCRIPTION OF THE PREFERRED EMBODIMENTS

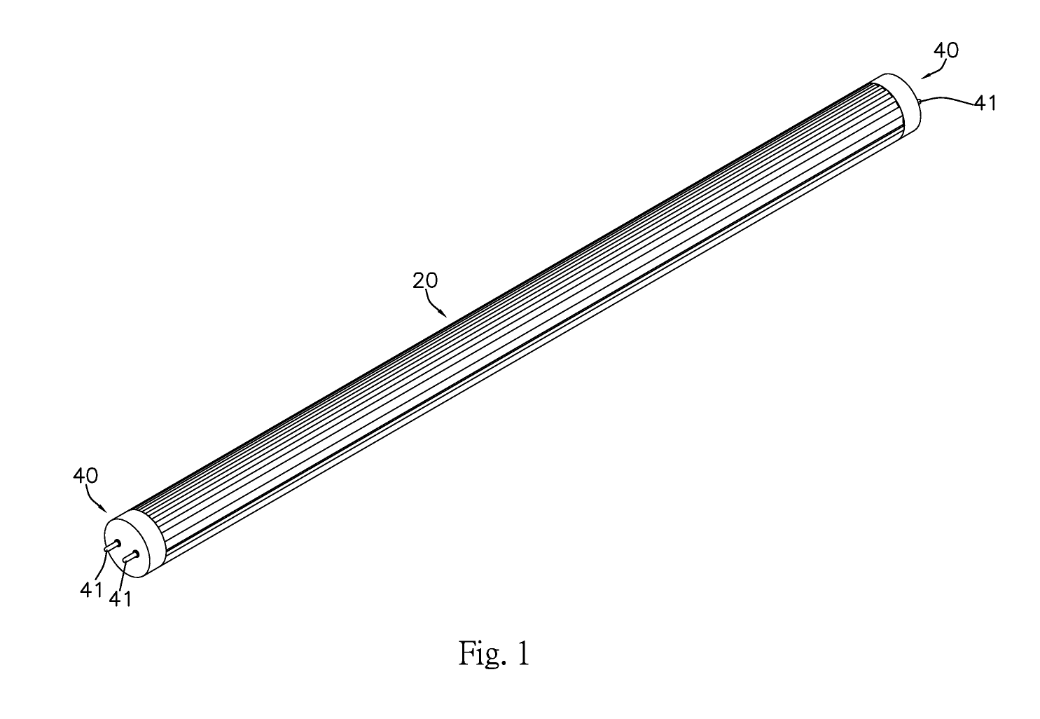

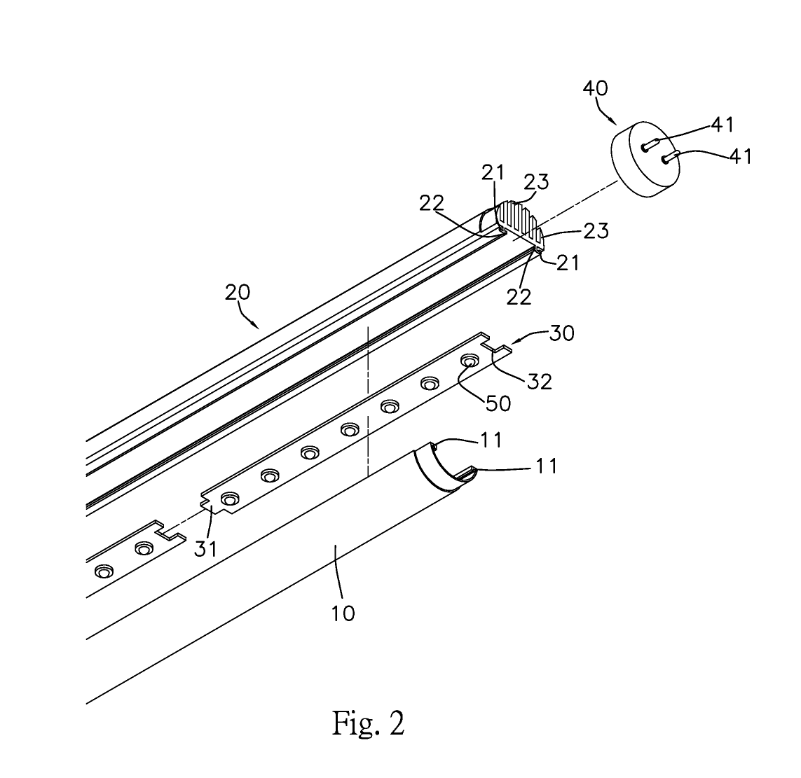

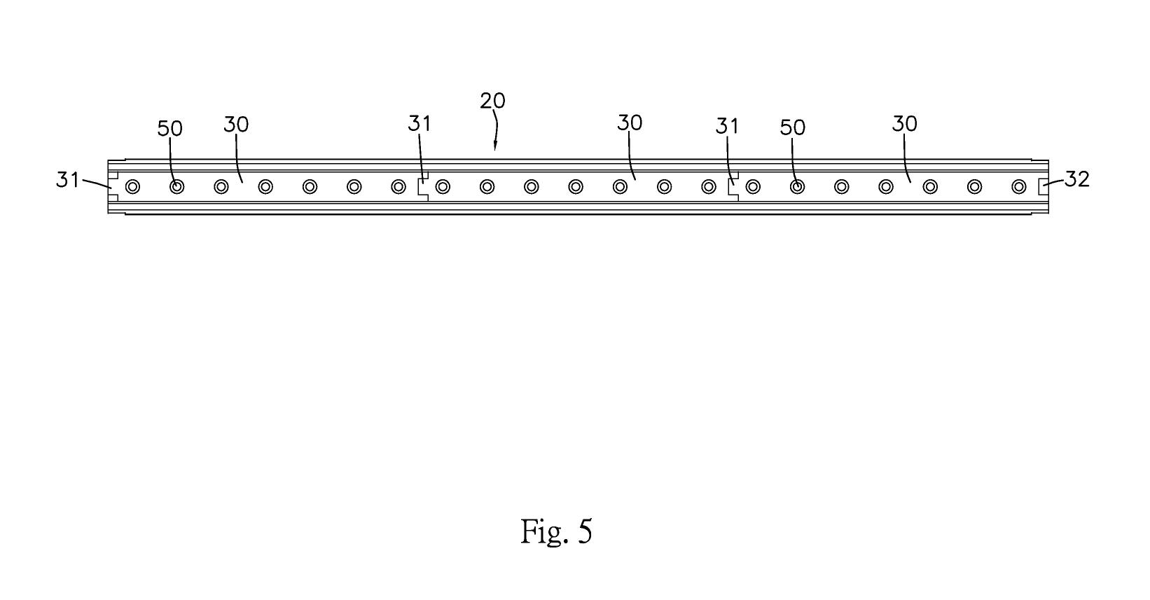

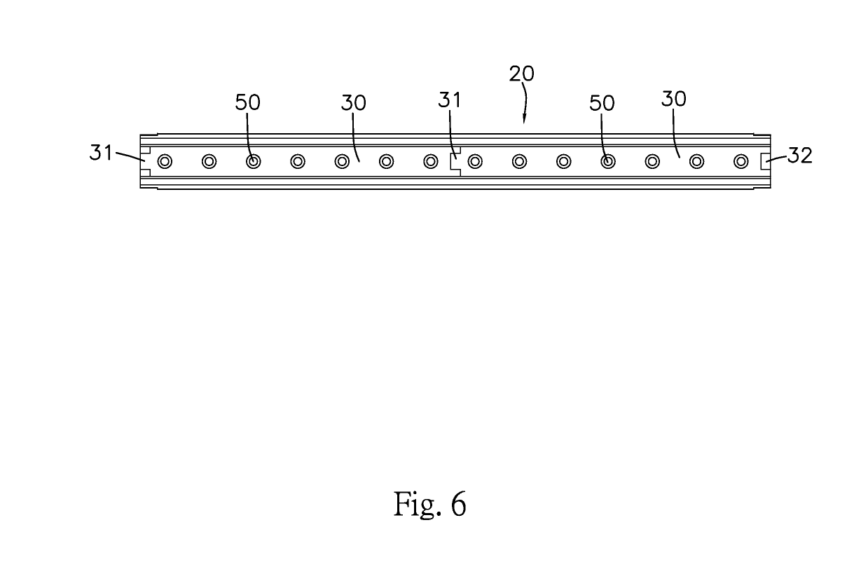

Referring to FIGS. 1-6, an embodiment according to the present invention is shown. The present invention provides a structure of safety LED (Light-Emitting Diode) lighting tube, which comprises a light cover 10, a base 20, a circuit board 30, and two electrical connectors 40. The light cover 10 comprises a semi-circular hollow body made by molding of a moldable material and having two opposite side edges extending inward and recessed to form rail channels 11. The base 20 comprises a semi-circular body made by molding of a moldable material and having a lower surface from which two hooked flanges 21 project for slidably mating the rail channels 11 formed on the two side edges of the light cover 10. Each of the hooked flanges 21 has an inward edge forming a rib 22 opposite to the hook. The base 20 has an upper portion forming a plurality of fins 23. The circuit board 30 is received between and supported by the ribs 22 formed on the inward edges of the hooked flanges 21 formed on the lower surface of the base 20. The circuit board 30 carries LEDs 50 thereon. The electrical connectors 40 are arranged at opposite ends of the base 20 and are in electrical connection with the circuit board 30. Each of the electrical connectors 40 comprises polarized contact terminals 41 for coupling with an external power source. Such an arrangement provides a structure of lighting tube that is of the advantages of energy conservation, excellent heat dissipation performance, excellent illumination brightness, environmental friendliness and recyclability, and improved safety.

The light cover 10 and the base 20 can be made of a moldable material that is colored for lighting and identification purposes. The materials that are used to make the light cover 10 and the base 20 are preferably plastics. The circuit board 30 forms a projection 31 and a recess 32, preferably at opposite ends thereof, whereby a plurality of circuit boards 30 can be jointed to each other through mating of projection and recess of adjacent ones of circuit boars in order to accommodate various overall length of the lighting tube, and/or the number of LEDs 50 set on the circuit board 30 can be changed according to desired requirement. Conductor wires are provided between adjacent ones of circuit boards 30 for electrical connection therebetween. The fins 23 formed on the upper portion of the base 20 are preferably integrally formed as a unitary structure and extend vertically. Alternatively, the fins 23 of the base 20 may be formed integrally and extend in an outward diverging fashion by bending toward opposite sides.

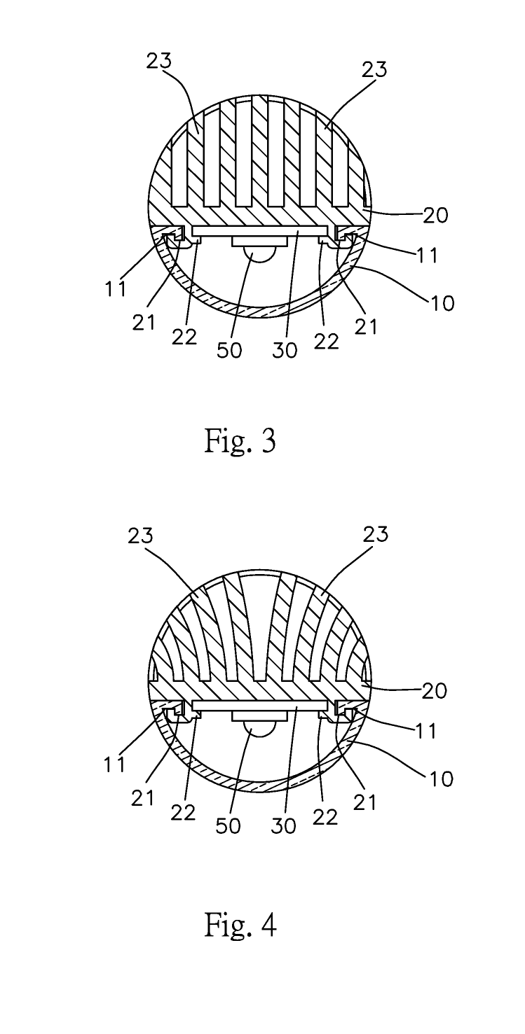

Referring to FIGS. 1-6, a preferred form of the safety LED lighting tube according to the present invention comprises a light cover 10, a base 20, a circuit board 30, and two electrical connectors 40, wherein the light cover 10 comprises a semi-circular hollow body made by molding of a moldable material, which is preferably a plastic material or the likes, and has two side edges that extend inward and are recessed to form rail channels 11 for slidably mating and engaging the base 20. The base 20 comprises a semi-circular body made by molding of a moldable material and is coupled to the light cover 10 to form a cylindrical configuration of the lighting tube, wherein the moldable material is preferably a plastic material or the likes. The moldable materials for the base 20 and the light cover 10 can be added with different color pigments or coloring agents in the process of injection molding in order to change the appearance colors thereof. The different color applied to the light cover 10, when irradiated by the light from the LEDs 50, allows the light that transmits through the light cover 10 to convert to different lights due to the color of the light cover 10 in order to increase the use thereof. The lower surface of the base 20 forms two projecting hooked flanges 21, which are in slidable and mating engagement with the rail channels 11 formed on the side edges of the light cover 10, so that the hooked flanges 21 of the base 20 are slidable into the rail channels 11 of the light cover 10 and a projection-and-recess engagement is formed to ensure stable coupling between the hooked flanges 21 and the rail channels 11. The upper portion of the base 20 forms a plurality of connected fins 23, which facilitates heat dissipation. The fins 23 are integrally formed with the base 20 and extend straight vertically (as shown in FIG. 3), or alternatively, the fins 23 are integrally formed with the base 20 and extend vertically but in an outward diverging fashion by bending to opposite sides (as shown in FIG. 4). It is apparent that, besides these two types, other configurations and arrangements may be adopted for the fins. Further, the lower surface of the base 20 comprises two ribs 22 formed on inward edges of the two hooked flanges 21 for engaging and supporting the circuit board 30. The circuit board 30 carries thereon LEDs 50 and other electronic components/parts and ballasts (not shown). The number of the LEDs 50 can be singular or plural according to the desired light source. The LEDs 50 are mounted through surface-mount technology (SMT) or bonded with other technologies to give off light. The circuit board 30 forms a projection 31 and a recess 32, wherein the projection 31 is formed on one end of the circuit board 30, while the recess 32 is defined in an opposite end of the circuit board 30. With the arrangement of the projection 31 and the recess 32, two circuit boards 30 can be jointed to each other through engagement between the projection and the recess, whereby the overall length of the combined circuit boards 30 can be adjusted to accommodate a desired specification of the lighting tube, with the lengths of the light cover 10 and the base 20 selected accordingly. Conductor wires are provided between adjacent ones of the circuit boards 30 for electrical connection therebetween. Opposite ends of the combined light cover 10 and base 20 are respectively provided with electrical connectors 40, which are arranged to correspond to the circular circumference of the combined light cover 10 and base 20 to fit over and hoop the light cover 10 and the base 20 together, preventing the light cover 10 and the base 20 from separation due to undesired and unexpected sliding motion therebetween. The electrical connectors 40 comprise polarized contact terminals 41, which, in the internal side, are electrically connected to the circuit board 30 and, in the external side, are connectable to holding seats of the lighting tube (not shown) for connection with external power source so that external power can be supplied through the polarized contact terminals 41 to the LEDs 50 on the circuit board 30 for light emission.

In summary, the safety LED lighting tube according to the present invention offers the following advantages:

(1) The base has an upper portion forming a plurality of fins, which can be of various forms, whereby heat dissipation performance of the lighting tube is improved. This, when combined with the inherent characteristic of LED that consumes less power than the conventional fluorescent tubes and also generates less amount of heat, helps reducing power consumption, extending lifespan of lighting tube, and thus improving practicability of the present invention.

(2) Both the light cover and the base are made of moldable materials, of which the colors may be modified to provide an attracting outside appearance and further, with the expandable combination of one or more circuit boards, the lighting tube can be modified as desired in respect of the size and brightness. The materials of the lighting tube are recyclable and thus environmentally friendly so that the functionality of the present invention is further improved.

What is claimed is:

1. A safety LED (Light-Emitting Diode) lighting tube, comprising:
a light cover, which comprises a semi-circular hollow body made of a moldable material and has two side edges extending inwards and recessed to form rail channels;
a base, which comprises a semi-circular body made of a moldable material and has a lower surface from which two hooked flanges project for slidable engagement with the rail channels formed on the side edges of the light cover, ribs being formed on inward edges of the hooked flanges, the base having an upper portion forming a plurality of fins;
a circuit board, which is received between and supported by the ribs formed on the inward edges of the hooked flanges of the lower surface of the base, the circuit board carrying thereon at least one LED; and
two electrical connectors, which are respectively mounted to opposite ends of the base and are electrically connected to the circuit board, the electrical connectors comprising contact terminals for electrical connection with an external power source.

2. The safety LED lighting tube according to claim 1, wherein the moldable materials making the light cover and the base carry colors for identification.

3. The safety LED lighting tube according to claim 1, wherein the moldable materials making the light cover and the base comprise plastic materials.

4. The safety LED lighting tube according to claim 2, wherein the moldable materials making the light cover and the base comprise plastic materials.

5. The safety LED lighting tube according to claim 1, wherein the circuit board forms a projection and a recess, and wherein an additional circuit board is provided and jointed to the circuit board through projection-and-recess engagement for selectively setting a desired overall length of the lighting tube.

6. The safety LED lighting tube according to claim 5, wherein conductor wires are provided between the circuit board and the additional circuit board for electrical connection therebetween.

7. The safety LED lighting tube according to claim 1, wherein the fins are integrally formed with the base and extend vertically in a straight manner.

8. The safety LED lighting tube according to claim 1, wherein the fins are integrally formed with the base and extend vertically in an outward diverging fashion.
